(19) United States
(12) Patent Application Publication
(10) Pub. No.: US 2021/0310799 A1
(43) Pub. Date: Oct. 7, 2021

(54) APPARATUS, MEASUREMENT SYSTEM AND METHOD FOR CAPTURING AN AT LEAST PARTIALLY REFLECTIVE SURFACE USING TWO REFLECTION PATTERNS

(71) Applicant: Fraunhofer-Gesellschaft zur Förderung der angewandten Forschung e.V., Munich (DE)

(72) Inventors: Peter SCHMITT, Erlangen (DE); Günther KOSTKA, Erlangen (DE); Lars SEIFERT, Erlangen (DE); Carina BAUMGÄRTNER, Erlangen (DE)

(21) Appl. No.: 17/353,367

(22) Filed: Jun. 21, 2021

Related U.S. Application Data
(63) Continuation of application No. PCT/EP2019/086451, filed on Dec. 19, 2019.

(30) Foreign Application Priority Data
Dec. 21, 2018 (DE) 102018222888.4
Jan. 30, 2019 (DE) 102019201208.6
Jan. 31, 2019 (DE) 102019201272.8

(51) Int. Cl. G01B 11/25; G06T 7/521

(52) U.S. Cl. CPC G01B 11/254; G01B 11/2513; G06T 7/521

(57) ABSTRACT

An apparatus for capturing at least partially reflective surfaces includes a detection surface assembly, an illumination device configured to emit an illumination pattern toward the at least partially reflective surface so as so project, by reflection via the at least partially reflective surface, a first reflection pattern and a second reflection pattern onto the detection surface assembly. The apparatus includes a capturing unit configured to capture the first reflection pattern and the second reflection pattern from the detection surface assembly.

### CROSS-REFERENCES TO RELATED APPLICATIONS

This application is a continuation of copending International Application No. PCT/EP2019/086451, filed Dec. 19, 2019, which is incorporated herein by reference in its entirety, and additionally claims priority from German Applications Nos. DE 10 2018 222 888.4, filed Dec. 21, 2018, DE 10 2019 201 208.6, filed Jan. 30, 2019, and DE 10 2019 201 272.8, filed Jan. 31, 2019, all of which are incorporated herein by reference in their entirety.

### BACKGROUND OF THE INVENTION

The present invention relates to an apparatus, a measurement system and a method for capturing at least partially reflective surfaces using two reflection patterns obtained by reflection. The present invention further relates to inverse deflectometry shape measurement of at least partially reflective surfaces.

For the fast non-contact shape measurement of reflective objects, there is a lack of optical measurement methods that can be used to directly and unambiguously measure the shape of the object. For example, for the optical quality control of lenses of spectacles, measurements have so far often been performed on individual samples using the so-called phase measuring deflectometry (PMD). The reconstruction of the actual shape is based on a known nominal shape. This makes it possible to determine small deviations from the nominal shape. Due to the deflectometry measurement principle, there is an infinite number of possible combinations of location position and inclination angle of the surface to be measured for each detected light beam, which means that there is no unambiguous mathematical solution for the position-angle combination. This is often referred to as angle-height ambiguity. Due to this principle, shape measurement of unknown surface shapes is therefore not possible or only possible to a limited extent.

A well-known variation of the PMD method for the solution of the position-angle ambiguity is stereo deflectometry, in which the surface is observed with two cameras at different angles. By comparing the potential normal fields of both cameras, the true normal can be inferred.

In PMD-based inspection methods, the back side of the lens of the spectacle is typically matted and blackened so that the projected pattern is reflected only on the side of the lens of the spectacle to be measured. However, due to the matting, the test specimen cannot be used as a lens of a spectacle after the measurement. Therefore, controlling the production to 100% is not possible.

EP 3 199 943 B1 describes an apparatus and a method for capturing an at least partially reflective surface. This method of inverse deflectometry can be used for detecting local shape deviations on reflective surfaces. However, since this method does not eliminate the ambiguity of position and angle, it is only suitable to a limited extent for the shape measurement of reflective objects. In addition, a particular difficulty is that it is not possible to distinguish along the proposed laser fan beam a particular beam of the fan from neighboring beams, so that no information about the deflection of the laser beam within the laser plane can be obtained.

### SUMMARY

According to an embodiment, an apparatus for capturing at least partially reflective surfaces may have: a detection surface assembly; an illumination device configured to emit an illumination pattern toward the at least partially reflective surface so as so project, by reflection via the at least partially reflective surface, a first reflection pattern and a second reflection pattern onto the detection surface assembly; and a capturing unit configured to capture the first reflection pattern and the second reflection pattern from the detection surface assembly.

According to another embodiment, a method for capturing at least partially reflective surfaces may have the steps of: arranging a detection surface assembly; emitting an illumination pattern toward the at least partially reflective surface so as to project, by reflection via the at least partially reflective surface, a first reflection pattern and a second reflection pattern onto the detection surface assembly; and capturing the first reflection pattern and the second reflection pattern from the detection surface assembly.

The core idea of the present invention is to have recognized that the above object can be solved in the following manner: by generating a first reflection pattern and a second reflection pattern through reflection of an illumination pattern on an at least partially reflective surface and by capturing the reflection pattern from a detection surface assembly, two information sources with respect to the reflection by the at least partially reflective surface may be obtained. This makes it possible to reduce or eliminate the position-angle ambiguity, which leads to precise results and reduces, or avoids, the disadvantages of the conventional technology.

According to an aspect, an apparatus for capturing at least partially reflective surfaces includes a detection surface assembly with one or several detection surfaces. The apparatus includes an illumination means configured to emit an illumination pattern, i.e. one or several illumination signals, toward the at least partially reflective surface so as to project, by reflection via the at least partially reflective surface, a first reflection pattern and a second reflection pattern onto the detection surface assembly. The apparatus includes a capturing unit configured to capture the first reflection pattern and the second reflection pattern from the detection surface assembly.

This aspect has the advantage that a curvature or a surface defect of the at least partially reflective surface, or the at least partially reflective body, may have a different effect in both reflection patterns so that the position-angle ambiguity is low or eliminated.

According to an embodiment, a measurement system includes such an apparatus.

This aspect has the advantage that the measurement system may capture a multitude of shapes of at least partially reflective bodies.

According to an embodiment, a method for capturing at least partially reflective surfaces includes arranging a detection surface assembly, emitting an illumination pattern toward the at least partially reflective surface so as to project, by reflection via the at least partially reflective surface, a first reflection pattern and a second reflection pattern onto the detection surface assembly. The method includes capturing the first reflection pattern and the second reflection pattern from the detection surface assembly.

### BRIEF DESCRIPTION OF THE DRAWINGS

Embodiments of the present invention will be detailed subsequently referring to the appended drawings, in which:

FIG. 1 shows a schematic side sectional view of an apparatus for capturing an at least partially reflective surface according to an embodiment;

FIG. 2a shows a schematic side sectional view of an apparatus according to an embodiment, wherein an illumination means comprises two light sources or illumination sources;

FIG. 2b shows a further side sectional view of the apparatus of FIG. 2a;

FIG. 2c shows a schematic side sectional view of an apparatus according to an embodiment, configured to generate two reflection patterns from a single illumination pattern;

FIG. 2d shows a schematic side sectional view of a part of an apparatus with a beam splitter according to an embodiment;

FIG. 3a shows schematic diagrams of an illumination pattern according to an embodiment, which may be used in the embodiments described herein;

FIG. 3b shows a schematic graph of a further illumination pattern according to an embodiment, comprising a multitude of dots arranged along a line;

FIG. 4 shows a schematic side sectional view of an apparatus according to an embodiment, comprising a detection surface assembly with at least two separate detection surfaces;

FIG. 5a shows a schematic side sectional view of an apparatus according to an embodiment, wherein the illumination means is configured to emit the illumination pattern toward an object or body comprising the at least partially reflective surface;

FIG. 5b shows a schematic side sectional view of an apparatus with twice the amount of illumination means as compared to the apparatus of FIG. 5a; and

FIG. 6 shows a schematic flow diagram of a method according to an embodiment.

### DETAILED DESCRIPTION OF THE INVENTION

Before embodiments of the present invention are subsequently described in detail on the basis of the drawings, it is to be noted that identical or functionally identical elements, objects and/or structures or elements, objects and/or structures with the same effect are provided in the different figures with the same reference numerals so that the description of these elements illustrated in different embodiments is interchangeable, or may be applied to one another.

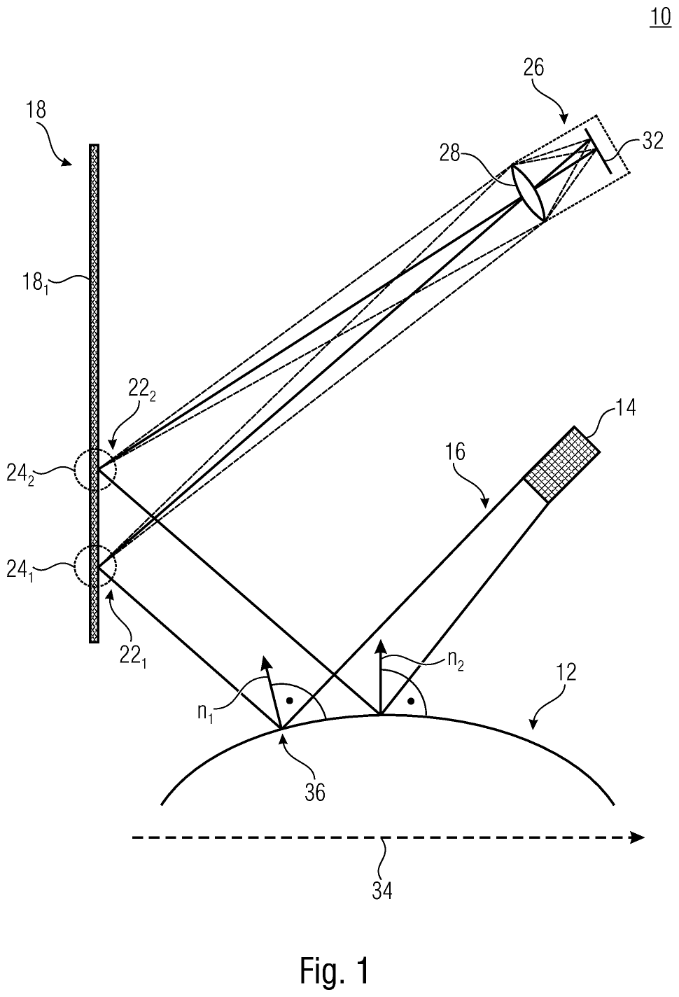

FIG. 1 shows a schematic side sectional view of an apparatus 10 for capturing an at least partially reflective surface 12. The at least partially reflective surface 12 may be configured to be reflective and/or mirroring at least in regions, e. g., and may be a reflective metal surface, however, it may be formed from another material, e. g., wherein some of the embodiments described herein refer to the measurement of optical bodies, in particular lens bodies such as lenses of spectacles, or the like. Alternatively or additionally, it is possible that the at least partially reflective surface is part of a painted metal sheet or a mirror surface. A painted metal sheet may be a gloss painted, transparently painted metal-reflective metal sheet. The at least partially reflective surface may alternatively be a ceramic surface to be measured and/or inspected. Alternatively, e.g., the apparatus 10 enables the measurement of other glossy technical surfaces.

Even though the subsequent explanations refer to partially reflective surfaces 12 in the form of lenses of spectacles, the explanations also apply to other at least partially reflective surfaces, such as those mentioned above, unless otherwise indicated.

An illumination means 14 is configured to emit an illumination pattern 16 toward the at least partially reflective surface 12. The illumination pattern 16 may include one or several individual patterns. Several individual patterns may be produced sequentially or simultaneously, which is described in detail in connection with embodiments. The illumination pattern is at least partially reflected at the at least partially reflective surface 12. Through the reflection, a directional deflection of the optical path takes place. Through the directional deflection, the optical path is deflected toward a detection surface 18₁ of a detection surface assembly 18 so that at least a first reflection pattern 22₁ and a second reflection pattern 22₂ are generated or obtained. The illumination means 14 is configured to project one or several patterns, e. g. a point of light, one or several lines, a stripe pattern or any other pattern, via reflection at the at least partially reflective surface 12 onto the detection surface 18₁. In this case, a position 24₁ of the first reflection pattern 22₁ and a position 24₂ of the second reflection pattern 22₂ depends on a local surface inclination with a surface normal n₁ and n₂, respectively, at locations, and depends on the locations 36 where the illumination pattern 16 is incident on the at least partially reflective surface 12. The positions 24₁ and 24₂ further depend on a radiation angle between the illumination means 14 and the surface normals n₁ and n₂.

The reflection patterns 22₁ and/or 22₂ may be projected using light, in particular laser light, e. g. using a laser light projector as the illumination source 14₁ and/or 14₂. Other sources which are suitable for generating a pattern on the at least partially reflective surface may also be used. This means that the illumination source 14 may use any light source for generating a defined pattern, e. g. LED, xenon lamps, mercury lamps, or the like, possibly using apertures or the like, and that the use of a laser light projector may be advantageous, but not mandatory. The laser light projector may be configured to emit a structured intensity distribution, e. g. in the form of a laser fan beam. An advantage of a reflection pattern projected using laser light is that, due to a greater Rayleigh length of the laser, e. g. in contrast to focused light of a projection lamp, an increased depth of field range of the laser may be used. Alternatively or additionally, the illumination means 14 may be configured to emit radiation of a short wavelength or a particularly short wavelength, such as ultraviolet (UV) light or extreme ultraviolet (XUV) light, so as to achieve a particularly high-resolution scan of the at least partially reflective surface 12. Highly focused UV or XUV radiation enables a high-resolution surface scan on the basis of the shorter wavelength. Alternatively or additionally, the illumination means 14 may be configured to emit long-wavelength radiation, such as infrared (IR) light.

These aspects have the advantage that a surface defect of the at least partially reflective surface 12 may be possibly captured indirectly with a zoom function at the detection surface 18₁. This enables a reduction of interfering influences, e.g., which may occur due to reflections. Simultaneously, light with a short wavelength may be used to project one or both of the reflection patterns 22₁ and 22₂ onto the detection surface 18₁ so that surface defects with a small spatial extension may be detected. Separating the reflection patterns of different wavelengths may still be possible, e. g., using color filters in a capturing means.

The radiation means 14 may comprise a radiation source for generating a defined pattern. This pattern may be projected onto the at least partially reflective surface sequentially several times so as to obtain several reflection patterns. Alternatively, it may be projected simultaneously, for which purpose several illumination sources may be used simultaneously so as to generate identical or different patterns. An assembly with a mutual light source may be used to generate two or several identical patterns, providing its pattern several times or multiple times in combination with a beam splitter. In other words, the illumination means 14 may comprise one or several, in particular two, illumination sources that may each be implemented independently as laser sources, in particular line projectors. The illumination sources may be configured to project a light fan beam onto the detection surface 18₁. The illumination pattern 22₁ and/or 22₂ may be formed of light, in particular of laser light, comprising visible wavelengths. Alternatively or additionally, the light projecting the pattern may also comprise other wavelengths such as UV light, XUV light, and/or IR light. Such wavelengths that are possibly invisible to the human eye or a capturing unit 26 may be converted into visible light, in particular for the capturing unit 26. Light converted into light that is visible to the human eye and scattered by the detection surface 18₁ may be captured by conventional silicon-based camera sensors. Alternatively or additionally, it is possible to use different wavelengths for a further or for the same inspection process, e.g., so as to capture different depth areas or inspection areas of the at least partially reflective surface 12.

For example, the detection surface 18₁ may be a diffusely-scattering non-transparent scattering film that is captured by the capturing unit 26 via a conventional imaging object 28 of the capturing unit 26 and/or a detector surface 32 of an electronic surface camera from a direction from which the reflection pattern 22₁ and/or 22₂ is projected onto the detection surface 18₁ (incident side). The capturing unit 26 may include a camera for a position determination of the reflection pattern, i.e. for a globular or a relative determination of a position of the reflection pattern 22₁ and/or 22₂. To this end, cameras having an integrated image evaluation may be used, e. g. 3D cameras. Alternatively or additionally, the capturing unit 26 may include a light section camera, for example.

Alternatively, the detection surface 18₁ may at least be partially transparent, e. g. a semi-transparent scattering film, so that the pattern may be captured from a side of the detection surface 18₁ facing away from the incident side. Thus, for example, a reflection pattern projected by a UV laser or XUV laser onto the detection surface 18₁ may be converted into visible light by phosphorescent or fluorescent materials at the detection surface 18₁ and may be scattered so that the pattern is visible on the side facing away from the incident side and may therefore be captured by the capturing unit 26 when the same is arranged so as to capture the side of the detection surface 18₁ facing away from the incident side.

For example, the capturing unit 26, e. g. a surface camera or line camera, may be configured as an electronic camera to capture the detection surface 18₁, e. g., such that the capturing unit 26 records a continuous or discontinuous sequence of images of the reflection patterns 22₁ and 22₂ projected onto the detection surface 18₁. To this end, the capturing unit 26 may comprise the imaging optics 28. In addition, the capturing unit 26 may comprise the detector surface 32, e. g. a camera chip or any other image sensor. The imaging optics 28 may be configured to compensate a varying distance between the at least partially reflective surface 12, the illumination means 14, and/or the detection surface 18₁ so that a focused image of the pattern may be imaged on the image sensor 32. The image sensor 32 may comprise one or several, e. g. silicon-based, sensors, in particular if the pattern is scattered at the detection surface 18₁ in light of visible wavelengths. However, alternatively or additionally, the illumination means 14 may be provided to be configured so as to consider, in the projection of the illumination pattern 16 onto the detection surface assembly 18, a variable distance between the illumination means 14 and the at least partially reflective surface 12 and to perform focusing onto the detection surface 18₁.

The positions 24₁ and 24₂ may be determined via corresponding positions on the detector surface 32.

FIG. 1 illustrates that the reflection pattern 22₁ and 22₂ are obtained by reflection at different locations with the surface normals n₁ and n₂, respectively. Eliminating the position-angle ambiguity is possible, for example, if the two reflection patterns 22₁ and 22₂ refer to an identical location at the at least partially reflective surface 12. For example, this may be achieved by moving the at least partially reflective surface 12 along a relative movement direction 34 so that, e. g., a first reflection pattern 22₁ recorded at a first point in time may be correlated with a reflection pattern 22₂ recorded at a second point in time, advantageously correlating or relating the images where the respective illumination signal was reflected at the same location of the at least partially reflective surface 12. This means that the apparatus may be configured to illuminate a surface point 36 of an object to be measured, or of the at least partially reflective surface 12, at a first point in time with a first illumination pattern so as to obtain the reflection pattern 22₁, and to illuminate the surface point 36 at a second different point in time, i.e. before or after, with a second illumination pattern so as to obtain the reflection pattern 22₂.

The movement direction 34 may be a lateral or translational movement direction, alternatively, it may also include at least one rotational portion. Both movement components may be used individually, but also in combination, so as to illuminate with the illumination pattern 16 all points of the at least partially reflective surface 12 to be inspected. The relative movement may be done by a movement of the at least partially reflective surface 12 with respect to the measurement assembly, or by a movement of the measurement assembly with respect to the at least partially reflective surface 12, a combination also being possible.

To generate the relative movement, e. g. along the relative movement direction 34, the apparatus 10 may comprise a positioning unit configured to perform a relative movement between the illumination means and the detection surface assembly 18 on the one hand and the at least partially reflective surface on the other hand, wherein, to this end, the illumination means may be moved together with the detection surface assembly and/or the at least partially reflective surface. The relative movement may include a translational movement and/or a rotational movement. The apparatus 10 may also comprise a distance measuring means, which is not illustrated, configured to capture or to measure the displacement or movement of the at least partially reflective surface. By knowing as exactly as possible the displacement caused by the positioning means, an exact link of the reflection patterns may be obtained since one may exactly determine when the patterns are projected at the same point or area of the at least partially reflective surface.

The capturing unit 26 may include a 3D measurement camera, such as a light section camera. These cameras may achieve measurement rates of more than 10000 profile measurements per second. A partial or full capturing of the at least partially reflective surface 12 may be achieved through a sequential high-frequency measurement of the reflection patterns 22₁ and/or 22₂ on the detection surface 18₁ during the relative movement 34 between the measurement assembly, i.e. the illumination means 14 and the detection surface assembly 18 as well as, possibly, the capturing unit 26 on the one hand the at least partially reflective surface 12 on the other hand. A light section measurement camera may enable a quick position determination of a light line pattern, or the position of a light line at the detection surface 18₁ so that a data reduction may be performed on the image sensor 32 or in the capturing unit 26. To this end, the capturing unit 26 may include a local evaluation unit configured to, e.g., evaluate the captured image line-by-line with respect to local or global intensity maximum. Several local intensity maximums may be evaluated, e.g., if both reflection patterns 22₁ and 22₂ are mutually captured be the capturing unit 26, e.g. in case of a projection onto a mutual detection surface 18₁. Several local intensity maximums may be evaluated, e.g., if the reflection patterns 22₁ and 22₂ are each captured individually by individually assigned capturing unit, e.g., in case of a projection onto a respective detection surface 18₁ of the detection surface assembly 18.

The capturing unit may be configured to output the corresponding line value(s) of the local or global maximum as a scalar. In particular, such a position determination enables a first data reduction and therefore a fast transfer of individual images to an evaluation means, since, instead of full images, only the extracted position information is transferred. In addition, a range of additional information, e. g. an intensity of the evaluated light line per measurement point or a line width per measurement point, may be provided. This additional information or data may be evaluated by means of additional evaluation steps. Thus, for example, a high-frequency variation of a brightness or a width of a line in the position-space in combination with the evaluation of the positional course of the line may be used to infer the existence of a defect. For example, the absence of at least part of a pattern in a certain area of the detection surface 18₁ may indicate a defect. For example, if a continuous curvature between two portions of the at least partially reflective surface 12 that are inclined with respect to each other is expected at the at least partially reflective surface 12, the continuous curvature may lead to the pattern crossing a certain area at the detection surface 18₁ due to the curvature. If the component has a defect, e. g. a kink-like transition, between the portions inclined with respect to each other, the pattern may possibly be shifted promptly from one area (capturing of the first portion of the at least partially reflective surface 12) to another area (capturing of the second portion inclined with respect to the first area) so that the reflection pattern is absent between the two areas of the detection surface 18₁. In principle, a variation of the reflection pattern, e. g. when expecting a constant pattern at the detection surface 18₁, or a non-variation of the pattern, e. g. when expecting a curvature of a projected line of the reflection pattern, may enable conclusions about a surface defect.

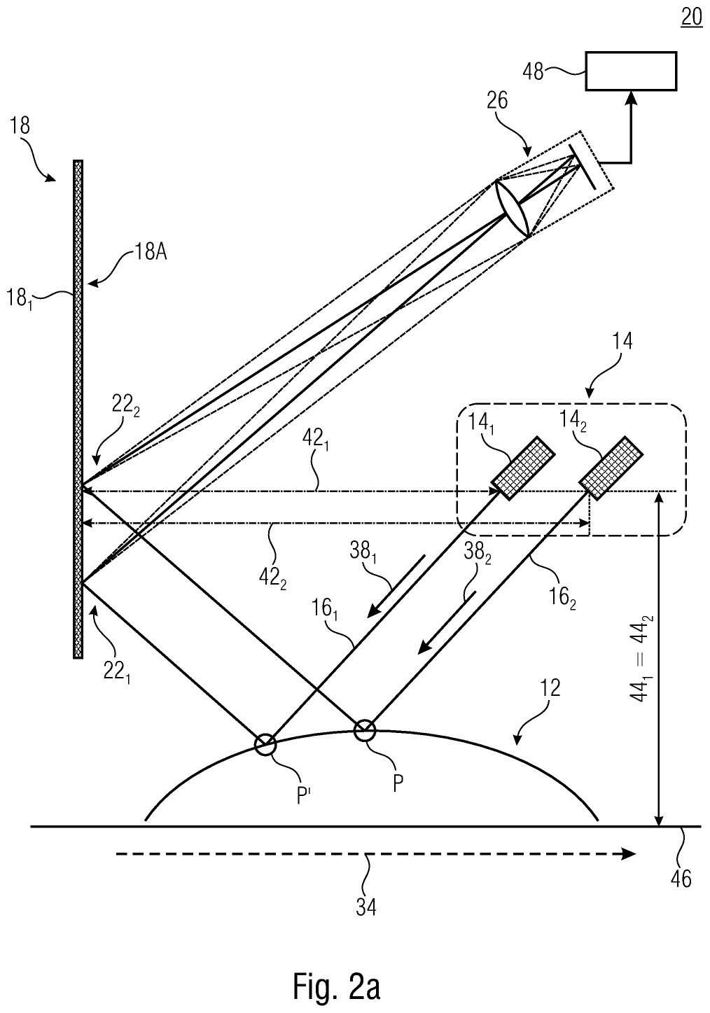

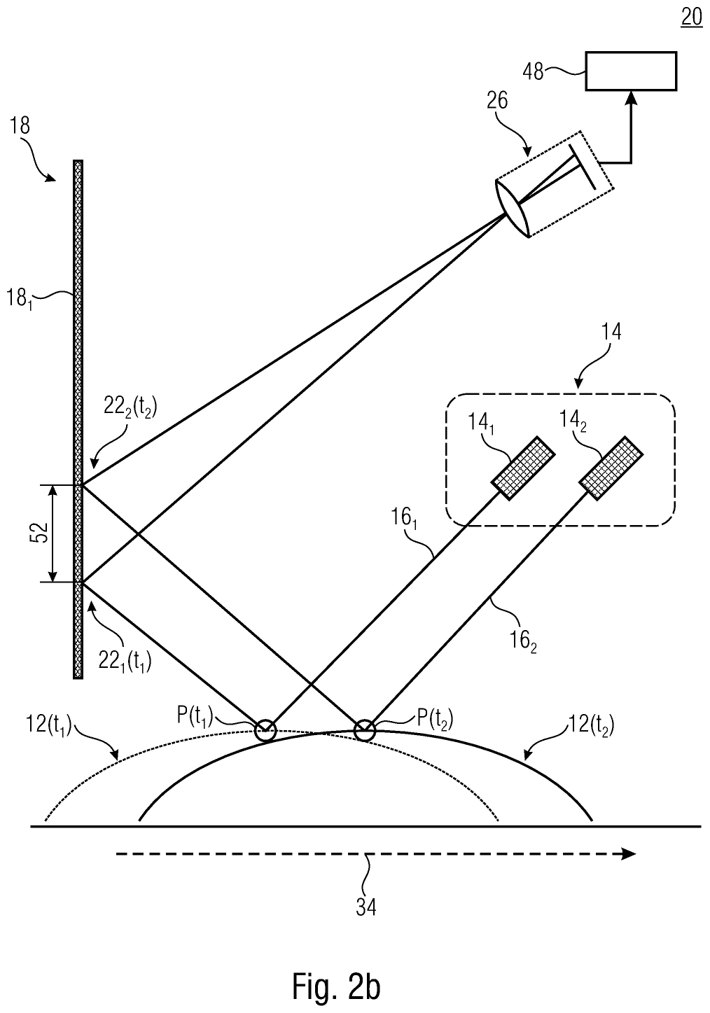

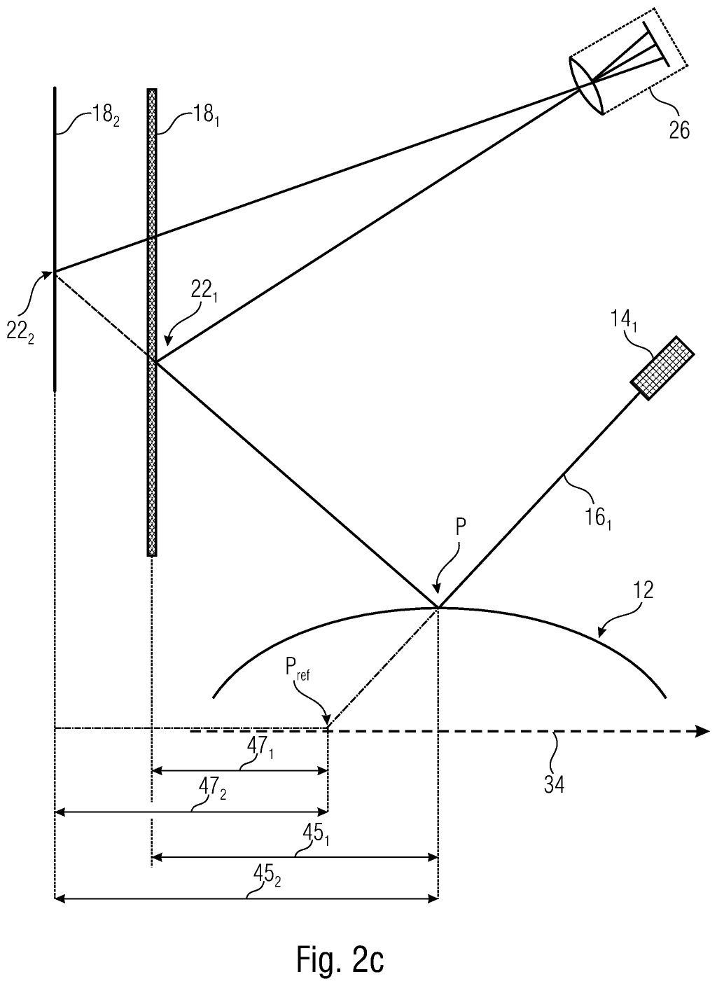

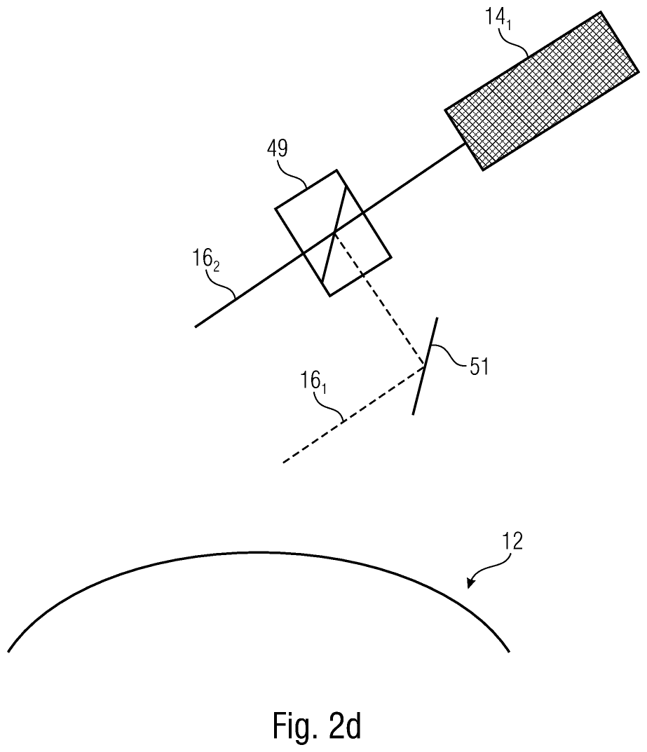

FIG. 2a shows a schematic side sectional view of an apparatus 20 according to an embodiment, wherein the illumination means 14 comprises two light sources or illumination sources 14₁ and 14₂. For example, the light sources 14₁ and 14₂ may include laser light projectors so as to direct a light fan beam onto the at least partially reflective surface 12. The light sources 14₁ and 14₂ may be arranged such that they emit along a respective direction 38₁ and 38₂ toward the at least partially reflective surface according to the illumination patterns 16₁ and 16₂. In this case, the light sources 14₁ and 14₂ may be arranged such that the directions 38₁ and 38₂ extend in parallel at least within a tolerance range of ten degrees, five degrees, or one degree or less. The light sources 14₁ and 14₂ may be arranged in an offset manner along the movement direction 34 so that a distance 42₁ between the light source 14₁ and the detection surface assembly 18, and a distance 42₂ between the light source 14₂ and the detection surface assembly 18 are different from one another. As a result, the directions 38₁ and 38₂ are arranged in an offset manner with respect to each other along the movement direction 34.

This enables obtaining different leg lengths or path lengths of optical paths between the light sources 14₁, via the at least partially reflective surface 12, to the detection surface assembly 18, and between the light source 14₂, via the at least partially reflective surface 12, to the detection surface assembly 18 with respect to an identical point P on the at least partially reflective surface 12.

The use of two light sources 14₁ and 14₂ makes it possible to generate the reflection patterns 22₁ and 22₂ simultaneously at the detection surface assembly 18. At a certain point in time, the reflection pattern 22₁ is generated by reflection in a first surface area, e. g. the region P′ illustrated as a point in the cross-section, and the reflection pattern 22₂ is generated by reflection of a surface area that is disjointed thereto, i.e. spatially separated, referred to as point P in the illustrated cross-section.

As described in connection with FIG. 1, the relative movement along the relative movement direction 34 may achieve that the point P is illuminated by the light source 14₁ and by the light source 14₂ in a temporal interval so as to obtain the corresponding illumination patterns 22₁ and 22₂, respectively, at the detection surface assembly 18. Through the different distances 42₁ and 42₂, a reflection to different locations and with a different zoom function and/or deflection angle may be obtained at the detection surface assembly 18. In particular, the distances 44₁ and 44₂ between the light source 14₁ and 14₂ may be identical with respect to a reference plane 46 arranged along a direction perpendicular to the distance 42₁ and 42₂. For example, the reference plane may be parallel to a means for carrying or holding or transporting the at least partially reflective surface 12.

A spatial difference between the reflection patterns 22₁ and 22₂ obtained in such a way at the detection surface assembly 18 may be evaluated by the apparatus, e. g. using an evaluation means 48 coupled to the capturing unit 26 and configured to receive the images received by the capturing unit 26 and/or further processed data. The evaluation means 48 may be configured to determine the inclination angle of the at least partially reflective surface 12 for each captured measuring point.

The lateral offset of the two directions 38₁ and 38₂ leads to a different path length between the illumination means 14, via the at least partially reflective surface 12, to the detection surface assembly 18 so that the first reflection pattern 22₁ and the second reflection pattern 22₂ are generated with a local difference at the detection surface assembly 18, wherein the local difference refers to a projection or reflection of the illumination signals at the same point P. The apparatus is configured to evaluate the local difference so as to enable the elimination of the position-angle ambiguity.

Thus, with respect to point P, different information may be obtained at different points in time, which enables to fully or partially eliminate the position-angle ambiguity.

In other words, FIG. 2 shows a schematic illustration of a measurement principle (arrangement of the camera, the surface to be inspected, the detection plane and the illumination/laser).

For further explanation, FIG. 2b illustrates a further side sectional view of the apparatus 20 of FIG. 2a. In contrast to FIG. 2a, the position of the at least partially reflective surface is illustrated at the time t₂, which is also illustrated in FIG. 2a, and further at a, e.g., time t₁. Through the displacement of the at least partially reflective surface 12 along the relative movement direction 34, the point P of FIG. 2a is arranged at different locations at times t₁ and t₂.

During the time t₁, the illumination pattern 16₁ is projected onto the point P so that the reflection pattern 22₁ is obtained at the detection surface assembly 18. At the time t₂, the point P is at a different location so that the illumination signal 16₂ is incident on the point P such that the illumination pattern 22₂ is obtained from the illumination signal 16₂ at the time t₂.

Through correlating the corresponding information from the reflection patterns 22₁ and 22₂ and evaluating a local difference 52 between the reflection pattern 22₁ and 22₂, under consideration of the geometry of the measurement assembly, the property, i.e. surface inclination and/or position/height, may be unambiguously determined at the at least partially reflective surface 12.

The reflection patterns 22₁ and 22₂ at the detection surface assembly 18 are distinguishable by the capturing unit 26 and/or the evaluation unit 48. This enables the emission of the illumination signals 16₁ and 16₂ at the same time performing the relative movement and a corresponding correlation of the corresponding partial images. However, it is also possible to consecutively emit the illumination signals 16₁ and 16₂, e. g. by again performing the relative movement, which enables a simple implementation of the illumination means 14 since it is no longer important to be able to distinguish the reflection patterns 22₁ and 22₂ at the detection surface assembly 18.

A distinction of the reflection patterns 22₁ and 22₂ at the detection surface assembly 18 may be provided by different means. Thus, for example, in case of an approximately known and expected shape of the at least partially reflective surface 12, an area of the reflection patterns 22₁ and 22₂ may also be approximately known or expected. As a result, a local delimitation of the two reflection patterns 22₁ and 22₂ and a delimitation in the recognition or identification may be obtained. However, this may limit the degrees of freedom with respect to the geometries to be examined.

While the apparatuses 10 and 20 are described such that the reflection patterns 22₁ and 22₂ are simultaneously captured from the detection surface 18₁, and corresponding illumination patterns are simultaneously emitted to this end, embodiments also refer to obtaining the first reflection pattern 22₁ and the second reflection pattern 22₂ during different and disjointed, i.e. temporally non-overlapping, temporal intervals. Thus, for example, a first pass may be done by emitting the illumination signal 16₁ so as to only obtain the reflection pattern 22₁ or 22₂. Subsequently, a new pass may be done, the at least partially reflective surface may again be moved along the relative movement direction 34, and the respectively other reflection pattern 22₁ or 22₂ may be generated. Even though the simple implementation possible though this is accompanied by a corresponding temporal effort, it is easily possible to link or correlate the corresponding recordings or images in the capturing unit 26 or the evaluation means 48.

FIG. 2c shows a schematic side sectional view of an apparatus 20′ according to an embodiment, configured to generate from an illumination signal, or an individual illumination pattern, two reflection patterns 22₁ and 22₂. To this end, the apparatus comprises a first detection surface 18₁ arranged in a first distance 45₁ to the surface point P of the at least partially reflective surface 12 of the object to be measured, e. g. along the relative translational and/or rotational movement direction 34, i.e. along the travel path. A second detection surface 18₂ is arranged in a second, e. g. larger, distance 45₂ to the surface point P. This achieves that the illumination pattern 16, or the illumination signal 16₁, may generate both reflection patterns 22₁ and 22₂ after the reflection at the at least partially reflective surface 12. This means that, in contrast to a temporally offset generation, as exemplarily described on the basis of FIG. 2b, at least two reflection signals 22₁ and 22₂ may be simultaneously obtained from a, possibly, single illumination pattern 16₁. While this is done in the example of FIG. 2a and FIG. 2b by means of an illumination of the surface point P with illumination signals whose sources have different distances to the detection surface, a similar or equivalent gain of information is carried out through the different distances of the detection surfaces 18₁ and 18₂ with respect to the surface point P.

Since the position of the surface point may be entirely or partially unknown in a later operation during the assembly of the apparatus 20′, a reference point P_{ref} at which, e. g., the illumination pattern 16 is projected if the respective surface 12 is not arranged, e. g. a surface of a transport means, may be used for setting the different distances. The detection surfaces 18₁ and 18₂ may again have different distances 47₁ and 47₂, respectively, to this reference point P_{ref} along the relative movement direction 34 so as to obtain the additional information, since the reflection at the inclined surface point P influences the reflection patterns 22₁ and 22₂ differently.

To enable obtaining both reflection signals 22₁ and 22₂ from the illumination pattern 16₁, the detection surface 18₁ hit first by the reflection may be configured to be partially transparent or semi-transparent so that the second detection surface 18₂ may be arranged behind the first detection surface and is subsequently hit by the transmitting portion of the reflection, which may generate the reflection pattern 22₂. Through the partial transparency, simultaneous capturing of the reflection patterns 22₁ and 22₂ may be carried out with the capturing means 26, obtaining a highest possible parallelism of the reflected patterns, which enables exact measurements.

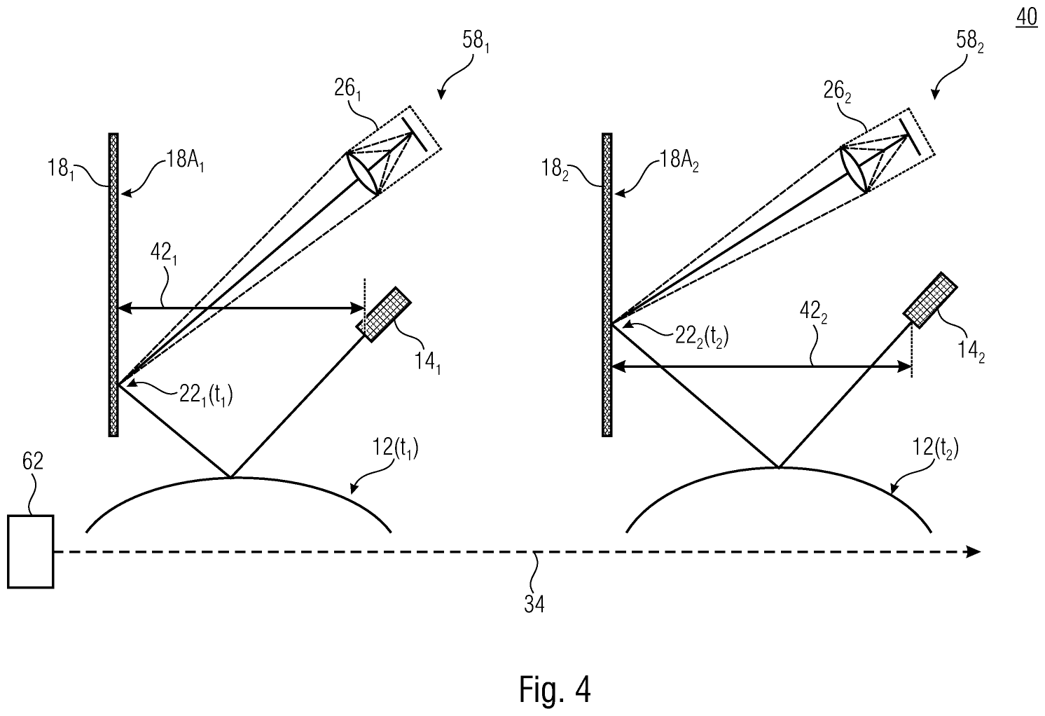

Alternatively, for example, it is possible that the detection surface 18₁ is at least partially reflective and reflects a reflected portion of the incident reflected illumination pattern onto the second detection surface 18₂, which may then be arranged opposite the detection surface 18₁, in contrast to the illustration in FIG. 2c. The capturing means 26 may have a correspondingly large field of view, however, it may also be configured using several capturing means, as is also described on the basis of FIG. 4.

To obtain several reflection patterns, the explanations of FIG. 2a, FIG. 2b, FIG. 2c may be combined with each other.

FIG. 2d shows a schematic side sectional view of a part of an apparatus according to an embodiment, e. g. the apparatus 10. To generate the two illumination patterns 16₁ and 16₂, as already described in connection with FIG. 1, a single illumination source 14₁ may be used whose output signal is split by a beam splitting element 49 so that a decoupled part of the output signal may be used as the illumination signal 16₁ after a new deflection by means of a reflective element 51, and a non-decoupled part of the output signal is available as the illumination signal 16₂. As a result, a first illumination signal 16₁ and a second illumination signal 16₂ are generated from the output signal of the illumination source 14₁. The decoupled and/or non-decoupled portion may again, possibly repeatedly, be split so as to generate additional illumination signals. The illumination signals 16₁ and 16₂ extend in parallel to each other. Through the distances and paths between the beam splitting element 49 and the reflective element 51, a lateral offset of the illumination signals may be generated, same as through a lateral offset of several illumination sources.

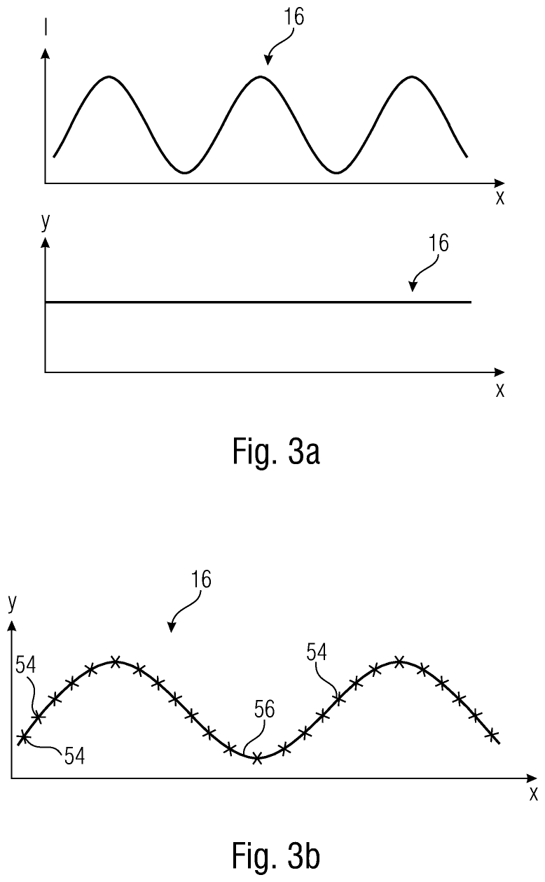

FIG. 3a shows schematic diagrams of an illumination pattern 16, e.g., which may be used as the illumination pattern 16₁ and/or 16₂. For example, the illumination pattern 16 has a line shape, e. g. in FIGS. 2a and 2b extending perpendicularly to a viewing plane of the respective figure in and which may be only represented as a point. The illumination pattern 16 may comprise a variable intensity progression within the illumination pattern 16 along a line progression, e. g. along an x direction perpendicular to a y direction. The intensity progression may introduce a type of coding into the illumination pattern 16 so that different intensity progressions may lead to distinguishable patterns on the detection surface assembly 18. For example, the intensity progression of the intensity I may be sinusoidal along the direction x, including different phase shifts or variations of a purely sinusoidal function, e. g. a cosine function or the like. Alternatively or additionally, modifications thereof may be implemented, e. g. a sinc function.

FIG. 3b shows a schematic graph of a further illumination pattern 16, comprising a multitude of points 54 arranged along a line 56. A progression of the line 56 may be different between different illumination patterns and may therefore enable a distinguishability of the reflection patterns 22₁ and 22₂. A multitude of points may be emitted by means of the light sources 14₁ and/or 14₂, e. g., by using a light grating or diffraction grating for splitting laser light, or by individual projection.

The arbitrary geometry of the line, possibly unambiguous within the illumination pattern used, and the modulation of the intensity may be combined in any way.

For example, when using the light sources 14₁ and 14₂ to emit the illumination patterns 16₁ and 16₂, the illumination patterns may differ by at least one of a geometry of the illumination pattern, an intensity distribution within the illumination pattern, and a wavelength of the illumination pattern, any combination being possible.

Thus, the illumination patterns 16₁ and 16₂ may differ with respect to the wavelength used, for example. In this case, the wavelengths may be selected such that a body with the at least partially transparent surface is at least partially transparent for at least one of the two wavelengths, i.e. at least 50%, at least 60%, at least 80%, or more. For the other wavelength, the body may be configured to be mostly nontransparent, i.e. with a transparency of at most 50%, at most 40%, or at most 30%, or less. This enables the wavelength for which the body is at least partially transparent to be also or mostly reflected at a rear side of the body, so that additional information about the rear side of the object to be examined 12₁ is obtained at the detection surface 18. The capturing unit may be configured to be sensitive to both wavelengths according to the wavelength illustrated at the detection surface 18₁ or obtained by means of fluorescence/phosphorescence. According to an embodiment, it is also possible to arrange different cameras that are adapted to the respective wavelengths of different illumination patterns, or reflection patterns. To this end, for example, frequency selective filters, or color filters may be used.

The evaluation means 48 may be configured to evaluate the at least partially reflective surface 12 by correlation of the reflection patterns 22₁ and 22₂ for the mutual point P. In this case, the evaluation means 48 may consider a temporal displacement, a location in the pattern, or other parameters so as to provide an evaluation basis for the evaluation of the at least partially reflective surface 12, e. g. a surface progression, a topography, local differences in the reflectivity, or the like. Among other things, the evaluation means 48 may evaluate a local difference obtained between the local differences between the reflection patterns 22₁ and 22₂ with respect to a same point, e. g. the local difference 52.

Alternatively or additionally, the evaluation means 48 may be configured to evaluate the reflection patterns 22₁ and 22₂ with respect to a position in the detection surface assembly 18, a brightness, or an intensity, a brightness distribution, an intensity distribution, and/or a deformation. The evaluation means 48 may be configured to repeatedly obtain images from the capturing unit 26, e.g. while the relative movement along the relative movement direction 34 is performed. Positions of the reflection patterns 22₁ and/or 22₂ may be evaluated in the respective images, e. g. by correlation. Thus, a first image may be captured and evaluated with respect to the reflection pattern 22₁ and may be correlated to a second image which is evaluated with respect to the reflection pattern 22₂, wherein the images are recorded such that the reflection is recorded at a corresponding area or location of the at least partially reflective surface 12.

FIG. 4 shows a schematic side sectional view of an apparatus 40 according to an embodiment, which may comprise a functionality that is identical or comparable to the apparatus 20. In contrast to the apparatus 20, however, the detection surface assembly may comprise two separated detection surfaces 18₁ and 18₂. In addition, the apparatus 40 may comprise two separate capturing units 26₁ and 26₂, wherein a respective capturing unit is configured to capture a detection surface 18₁ and 18₂, respectively, associated thereto. Thus, the at least partially reflective surface may therefore be measured by using two capturing means that are spaced apart or separated, wherein the at least partially reflective surface is moved by means of the translational, alternatively or additionally rotational, movement between the measuring means with the illumination source 14₁ or 14₂, the detection surface 18₁ or 18₂, and the capturing means 26₁ or 26₂, respectively. In this case, the reflection of different patterns may be implemented at the same point or area on the at least partially reflective surfaces.

The distances 42₁ and 42₂ between the light sources 14₁ and 14₂, respectively, and the associated detection surfaces 18₁ and 18₂, respectively, are different so as to obtain the additional information gain described in connection with FIG. 2a.

This makes it possible to project only one reflection pattern 22₁ or 22₂ each at one detection surface 18₁ and 18₂, respectively, so that a differentiation of the reflection patterns 22₁ and 22₂ in a capturing unit may be omitted. The at least partially reflective surface 12 may be moved between a first measurement setup 58₁, including the light source 14₁, the detection surface 18₁, the capturing unit 26₁, and a second measurement setup 58₂, including the light source 14₂, the detection surface 18₂ and the capturing unit 26₂, with displacement along the movement direction 34. To this end, the apparatus 40 may comprise the positioning means 62 mentioned in connection with other embodiments.

The light sources 14₁ and 14₂ are orientated in parallel so as to be able to eliminate the described ambiguity. For example, a non-parallel arrangement is useful if the surface is translated not exclusively linearly, e.g., but is at least partially rotated, so that the second laser detection unit is also arranged to be rotated with respect to the first one, following the rotation movement.

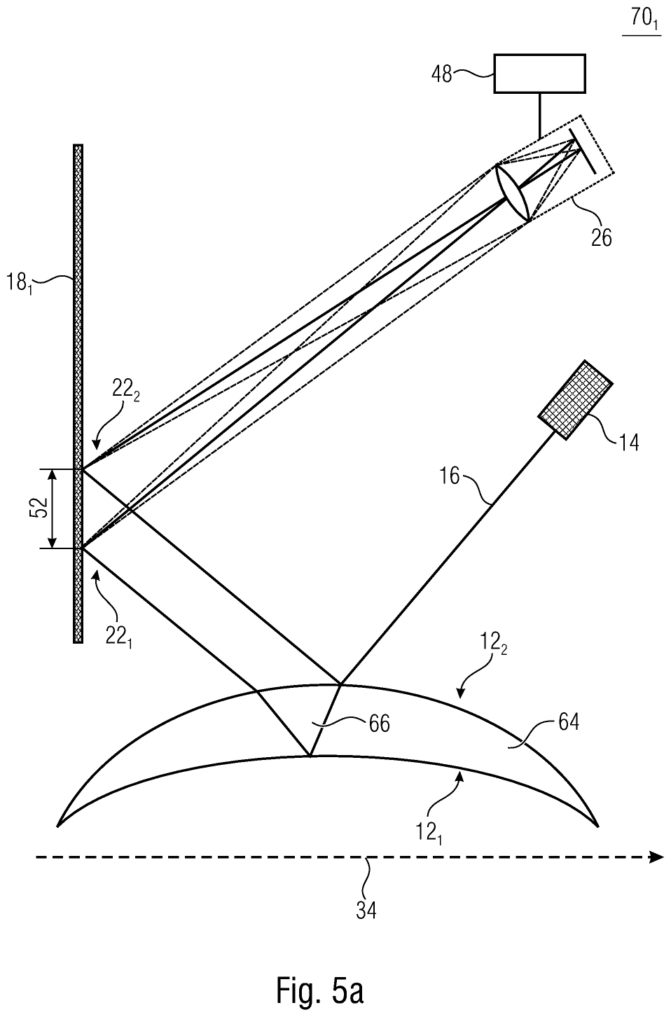

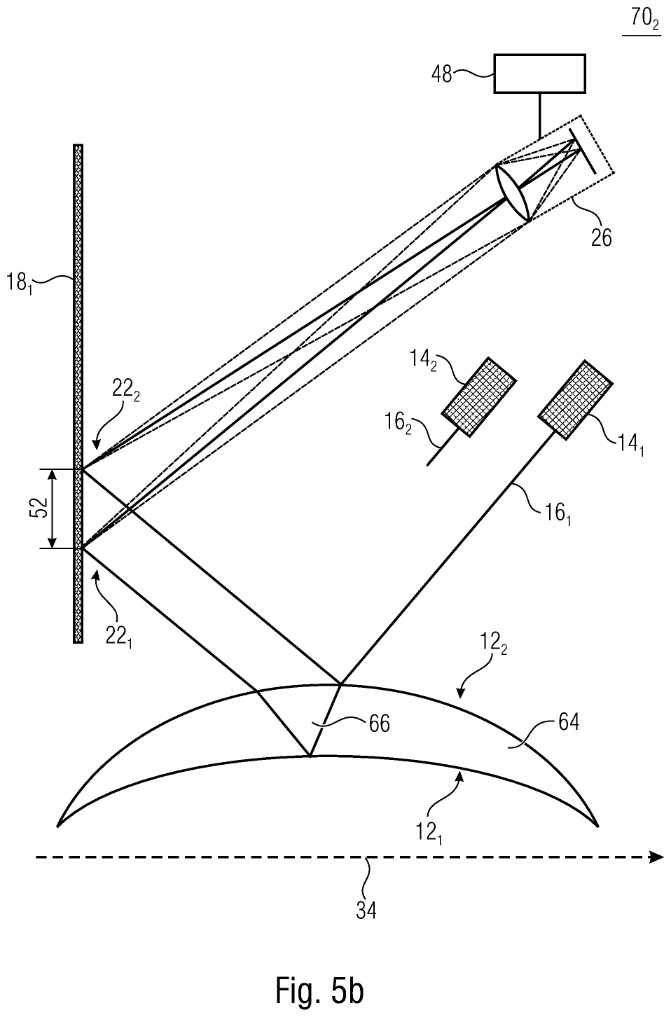

FIG. 5a shows a schematic side sectional view of an apparatus according to an embodiment. Referring to the apparatus 10, the illumination means 14 is configured to emit the illumination pattern 16 toward an object or body comprising the at least partially reflective surface 12₁. The same may be arranged facing away from the illumination means 14 so that a partially reflective and partially transparent surface 12₂ of the body 64 faces the illumination means 14. If the at least partially reflective surface 12 described in connection with the apparatus 10 is only partially, i.e. incompletely, reflective, the partially reflective surface 12 of FIG. 1 may also be arranged facing the illumination means 14. The body 64 is at least partially transparent so that a non-reflected portion 66 of the illumination pattern 16 passes through the body of the object 64 and is fully or partially reflected at the surface 12₁. Again, this results in two reflection patterns 22₁ and 22₂ at the detection surface 18₁, wherein each of the reflection patterns 22₁ and 22₂ enables a surface evaluation of the respective surface 12₁ and 12₂, respectively, and the spatial distance 52 enables a conclusion as to how the body 64 is formed between the two surfaces 12₁ and 12₂. Such a configuration is particularly advantageous for optical components, e. g. lenses or lenses of spectacles. That means that the reflection pattern 22₂ is generated by partial reflection of the illumination pattern 16 at the partially reflective surface 12₂. The reflection pattern 22₁ is generated by an at least partial reflection of a remaining portion 66 of the illumination pattern 16 at the at least partially reflective surface 12₁.

The evaluation means 48 may be configured to evaluate a surface quality of the surfaces 12₁ and/or 12₂. In the present embodiment, the position-angle ambiguity is not yet eliminated. However, it is possible to specify a target shape to which the surface quality is compared in the evaluation means 48. To this end, a comparison between the reflection pattern 22₁ and a corresponding reference pattern, and a comparison between the reflection pattern 22₂ and a corresponding reference pattern may be performed.

The apparatus 70₁ may be combined with a further illumination source 14, e.g., so that a total of three or even four reflection patterns may be obtained at the detection surface assembly, enabling to measure arbitrary at least partially transparent bodies as well. Thus, e. g., the apparatus 70₁ could implement one or both of the measurement setups 58₁ or 58₂. Other combination possibilities are also possible.

FIG. 5b shows a schematic side sectional view of an apparatus 70₂ with two illumination means, as is exemplarily described for the apparatus 20. An optical path of the light source 14₂ is not illustrated separately, however, it may lead to obtaining at least one further reflection pattern at the detection surface 18₁ or at a further detection surface 18₂, as is described for the other embodiments described herein. This makes it possible to eliminate the ambiguity with respect to the angle position.

In other words, FIG. 5b shows a schematic illustration of the measurement principle for measuring a front side and rear side of an optical element. For simplicity, the optical path of the second light source is not drawn.

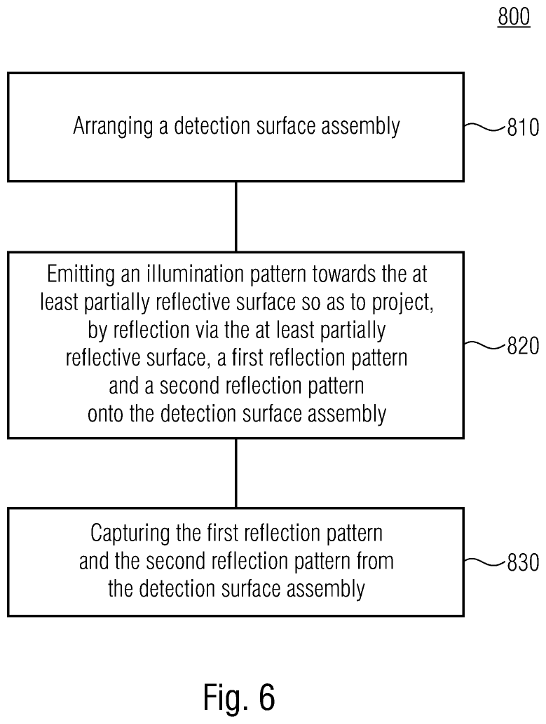

FIG. 6 shows a schematic flow diagram of a method 800 according to an embodiment. A step 810 includes arranging a detection surface assembly. A step 820 includes emitting an illumination pattern toward the at least partially reflective surface so as to project, by reflection via the at least partially reflective surface, a first reflection pattern and a second reflection pattern onto the detection surface assembly. A step 830 includes capturing the first reflection pattern and the second reflection pattern from the detection surface assembly.

The method is performed such that it is executed while performing a translation. This means that a step of the method may include performing a translational movement so that a relative movement between the illumination means and the detection surface assembly on the one hand and the at least partially reflective surface on the other hand is performed, as is described in connection with FIG. 1. The method may be performed such that the exact translation distance is known, in particular with respect to the path covered between the two reflection patterns to be linked, both as a target size (plane surface) and an actual size (driven actuating elements), and is considered for the calculations. According to embodiments, this is achieved by using a translational and/or rotational movement unit, e. g. the positioning means 62 disposed to this end, and as exact a position determination as possible achieved by using a path length measurement system.

In other words, the technical field of application of the embodiments described herein is the contactless shape measurement of high-gloss object surfaces, in particular technical glasses such as lenses and lenses of spectacles. A possible application of the method is the shape measurement for quality examination of varifocals with respect to their shape stability and/or their local refractive power. A topic in this context is the inverse laser deflectometry as a fast scanning imaging method of reflective surfaces. Furthermore, the method may be used for the shape measurement of reflective surfaces, lenses of spectacles and lenses. In contrast to previous standard methods of phase-measuring deflectometry, embodiments enable the simultaneous capturing of two surfaces. Embodiments enable an absolute geometry determination by means of dual inverse deflectometry according to the principle of solving two equations with two unknowns for each object point. One, but also multiple light pattern projectors may be used, e. g. two laser pattern projectors. Light pattern projectors with a structured intensity distribution may be used, e. g. a point pattern or a sinusoidal intensity pattern, i.e. a sinusoidal modulation. Embodiments concern the use of light pattern projectors aligned in parallel, the use of light pattern projectors with multiple wavelengths, the use of multiple detection surfaces or cameras, optionally with corresponding wavelengths filters, the orientation of the parallel aligned light pattern projectors at the mechanical translation movement unit, the positioning means 62, the use of two aligned or calibrated measurement stations or measurement setups, optionally in sequential order, and a suitable calibration method of the system.

The apparatuses described and the method for shape measurement of at least partially reflective surfaces may be performed such that reflective or partially reflective surfaces are automatically captured and measured during movement. This is possible by using the inventive arrangement of an optical measurement setup of one or at least two structured illumination means, advantageously arranged in parallel, one or several capturing units, e. g. surface cameras, recording a brightness image of one or several detection surfaces, the reflective or partially reflective surface to be captured, and a possibly computer-supported evaluation means.

A substantial improvement over previously available methods is that an unambiguous solution for the position and angle may be achieved for each capture point of the surface by using two illumination signals, e. g. by using two structured illumination means, and by the parallel arrangement of the laser pattern projectors (an alternative is the arrangement at the same location). Thus, it is possible to measure the object surface geometry while simultaneously determining the inclination angle and each measurement point.

In addition, the method enables the measurement of optical elements without blackening or marking the rear side. It is therefore possible to use the embodiments described herein in a 100% inspection, i.e. without inspection-related scrap. Furthermore, embodiments enable simultaneous measurement of the front and rear sides of a test object.

Embodiments are based on a corresponding arrangement of at least two light sources, advantageously in the form of two or more laser light projectors, the surface 12 of the body to be inspected, one or several detection surfaces, one or several measuring cameras, and a movement unit.

The laser light projectors, which are advantageously aligned in parallel, each project a light fan beam, also advantageously, with the same angle onto the surface. The light fan beam may be structured so as to facilitate the later allocation of the lateral measuring points, or to determine the deflection of the light beam in the light plane. A possible implementation would be the use of points located on an imaginary line, such as line 56, or of an intensity curve along the projected line that is modulated in another way, for example sinusoidally. The light specularly reflected by the surface is received by one detection surface or several detection surfaces and is diffusely scattered there, for example, so that it may be imaged by one or more measuring cameras onto the respective camera chip via imaging optics.

By using at least two laser light projectors, the position-angle ambiguity of the deflectometry method may be resolved and the surface shape may be determined directly within the limits of measurement accuracy. The inventive idea includes that the length of the optical path of the two reflected beams of the two laser light projectors is different between the reflective surface and the detection surface. Through the defined translation of the surface to be captured, it may be ensured that the same surface point is hit by both laser beams at different points in time and, due to the parallelism of the beams, they are reflected in the same direction according to the surface inclination angle. However, due to the different leg lengths of the reflected beams, both reflected beams are incident on a different relative position on the detection surface, or the detection surfaces, and are there captured via the measuring cameras. This makes it possible to mathematically determine the two values for the position and the inclination angle of each captured surface point within the scope of the measurement accuracy. The measurement accuracy may depend on or may be influenced by the accuracy of the system adjustment and calibration, the photonic noise of the camera image, the sharpness or definition of the laser light beams, and the optical resolution capacity of the cameras.

To avoid an overlap of the two reflected beams on a common detection surface/detection plane in case of very complex shaped surfaces, it may be convenient to vary the arrangement of the components in one of the following descriptions:
1. Two separate, but precisely aligned measuring setups with different distances between the laser (light source) and the detection plane: the sample to be measured is detected sequentially by both measuring setups, e.g., by means of a linear movement. By aligning the two measurement setups with respect to each other, same as when using only one mutual detection plane and camera, a unambiguous allocation of measurement data for the respective surface may be achieved. For example, such embodiments are described in FIG. 4.
2. Two temporally separated recordings in which only one laser light projector is switched off in each case may lead to the same base of information. This may also be implemented in FIG. 4. Other embodiments may be performed in such a way by a new pass through the object body.
3. The use of two different wavelengths for the laser light sources and two cameras with color filters matched to them.

In case of transparent objects, in order to achieve a separation of the beams reflected by the front side and the rear side of the object, it may be favorable to perform the measurement according to the above-mentioned principles with radiation of different wavelengths. In this case, it may accordingly be favorable to use different mutually aligned measurement setups each. For example, it is conceivable to perform the measurement of the front side with a wavelength for which the material is not transparent. A setup with an identical geometry but with a wavelength for which the material is transparent may be used for the measurement of the rear side. A distinction between the front side and the rear side may be obtained from the comparison of both measurements.

The position of the reflected laser light beams diffusely scattered by the detection plane may be determined automatically in the camera image. By a successive and sequential series of a plurality of such recordings during a relative movement by means of a movement unit between the surface to be measured and the metrological components (light sources, detection plane(s) and camera(s)), the information of a surface area, or the entire surface to be inspected, may be collected and assembled by means of an evaluation means 48, possibly using a computer program, and evaluated with respect to the determination of the surface shape.

In principle, any wavelength range may be used for the illumination patterns. The use of particularly shortwave (UV or XUV) or longwave radiation (infrared) is an example. The infrared, UV or XUV light may be converted into visible light on the detection plane, for example by phosphorescent material, in order to be detected by conventional silicon-based camera sensors. Furthermore, it is possible to use different wavelengths for the same inspection process, for example to detect different surface depth ranges or different inspection ranges. For the lateral detail resolution of the measurement, it may be advantageous to use a highly-focused laser light projector. If the surface height progression varies greatly, it may be advantageous to use a laser light projector with a particularly large Rayleigh length, i.e. a particularly large focal depth range of the laser. In special cases, it may be advantageous to use automatic motor-controlled focusing of the laser so as to capture as large an object area as possible with the best possible laser focus.

For example, the detection plane(s) may be diffusely scattering non-transparent or semi-transparent scattering film(s), which is (are) captured by one or more surface cameras from the front and/or from the rear via conventional imaging optics, or also the detector surface of one (or more) electronic surface camera(s). The detection plane(s) may be optically coupled, for example, via one or more so-called fiber optic tapers to one or more surface camera(s) without the use of additional imaging optics. Furthermore, the at least one detection plane may be the active area of one or more camera chips or one or more large TFT (thin-film transistor) areas or panels, e.g. a TFT flat panel detector. The at least one detection plane may be coated with phosphorescent material so that higher or lower energy radiation may be converted into visible light.

The incident structured fan beams reflected by the surface to be detected and deformed by the surface, which are expressed on the detection plane(s) as more or less deformed and structured light lines, may be captured by the at least one electronic camera and evaluated with respect to the position on the camera chip. The evaluation may also take place in the at least one camera itself. The separation of the images caused by the at least one laser light projector used may be done geometrically or by using different wavelengths. In addition, a time-delayed measurement may be performed, wherein only one laser light projector is activated at any given time. That is, the illumination device may be configured to emit the illumination pattern using a first wavelength range. The detection area assembly may be configured to convert the first wavelength range into a second wavelength range, so that the first reflection pattern and/or the second reflection pattern in the second wavelength range may be captured by the detection unit.

In addition to determining the position of the resulting structures, the brightness or possible deformation of the resulting structures on the detection plane(s) may also be evaluated. The detection unit 26 may comprise so-called 3D measurement cameras or light-section cameras, which allow measurement rates of several tens of thousands of profile measurements per second. According to embodiments, the lens of the spectacle to be measured is moved linearly while the at least one light source, the at least one camera, and the at least one detection plane remain at rest. Without limiting generality, the object may also remain at rest and the metrology components may be moved relative thereto, or a combination thereof may be performed. In the embodiment of the measurement of lenses of spectacles, light is generally reflected not only at the surface, but also at the bottom side, i.e. at the backside of the lens of the spectacle. This makes it possible to simultaneously measure the front side and the rear side, as described in connection with FIG. 5a.

In addition to apparatuses, embodiments also refer to measurement systems. Corresponding measurement systems may be configured to measure a measurement object with a surface to be captured, e.g. the at least partially reflective surface 12.

Embodiments refer to apparatuses, methods and measurement systems for measuring at least partially specularly reflective surfaces. Features thereof may include:
the use of one, two or more light sources for generating defined patterns, e.g. parallel beams, individually or as a light curtain or alternatively fan beam-like beams, e.g. structured light sources arranged in parallel, one (or more) detection plane(s), each coupled to a measuring camera, and a suitable arrangement of these metrological components relative to the surface to be captured; and/or
the use of one, two or more laser projectors with a structured intensity distribution along the light beam, light curtain, or fan beam (e.g. points on a line or sinusoidally modulated line) as light source; and/or
the displacement of the sinusoidal phase of the light source in order to achieve a more accurate lateral position determination, the translation or movement may also be done step by step for this purpose; and/or
the use of a single laser projector with a structured intensity distribution along the fan beam (e.g. points on a line or a sinusoidally modulated line) as a light source for measuring a reflective surface. In this case, the position-angle ambiguity is not resolved. By structuring, however, neighboring beams may be distinguished so that, starting from a known target shape, the surface may be approximately reconstructed; and/or
the complete scan of the surface by a relative movement between a measurement assembly and the surface during the sequential light profile measurement by using the most accurate knowledge of the displacement; and/or
the complete scan by rotational movement using the most accurate knowledge of the displacement, e.g. by angle determination, for scanning essentially radially symmetric surfaces; and/or
the simultaneous use of different measuring assemblies according to the inventive principle for simultaneously capturing different surface areas in a mutual relative movement; and/or
the simultaneous capturing of beams of a transparent measurement object reflected by the front side and the rear side; and/or
the evaluation of the generated raw data on a separate measuring and evaluation computer by means of a computer program; and/or
the recording of the detection plane(s) from the rear side, i.e., e.g., through semi-transparent diffusely scattering film(s); and/or
the use of cameras with integrated image evaluation, e.g. 3D cameras (light section cameras) as measuring cameras for the rapid evaluation of the position of the resulting structures on the detection plane(s); and/or
the configuration of the detection plane(s) as an input surface of one (or several) optical fiber taper(s) to whose output surface one (or more) electronic camera chip(s) is (are) coupled; and/or
the use of one (or more) TFT flat panel detector(s) as detection plane(s); and/or
the use of light radiation with particularly short or long wavelengths (infrared, UV, XUV); and/or
the use of phosphorescent material on the detection plane(s) to convert a short or long wavelength radiation into visible light or long wavelength radiation; and/or
the use of a motorized laser focusing device for increasing the depth of field range of the laser projectors on the surface.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer. The data carrier, the digital storage medium, or the recorded medium are typically tangible, or non-volatile. A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Apparatus for capturing at least partially reflective surfaces, comprising:
a detection surface assembly;
an illumination device configured to emit an illumination pattern toward the at least partially reflective surface so as so project, by reflection via the at least partially reflective surface, a first reflection pattern and a second reflection pattern onto the detection surface assembly; and
a capturing unit configured to capture the first reflection pattern and the second reflection pattern from the detection surface assembly.

2. Apparatus according to claim 1, wherein the illumination device comprises a first illumination source as a first laser light projector configured to emit the first illumination pattern as a first laser fan beam along a first direction, and a second illumination source as a second laser light projector configured to emit the second illumination pattern as a second laser fan beam along a second direction, wherein, within a tolerance range of 10° and along a relative movement direction between the illumination device and the detection surface assembly on the one hand and the at least partially reflective surface on the other hand, the first direction and the second direction are arranged offset to each other and extend in parallel to each other and.

3. Apparatus according to claim 2, wherein the first illumination pattern comprises a first line pattern, and a first intensity progression of the first line pattern is variable along a progression of the line; wherein the second illumination pattern comprises a second line pattern, and a second intensity progression of the second line pattern is variable along a progression of the line.

4. Apparatus according to claim 3, wherein the first intensity progression and the second intensity progression vary according to a sinusoidal function.

5. Apparatus according to claim 2, configured to perform a first measurement and a second measurement in a time-offset manner, wherein at each point in time only one laser light projector for generating the first or second light fan beam is activated.

6. Apparatus according to claim 2, wherein the detection surface assembly comprises two separate detection surfaces, and the apparatus comprises two separate capturing units and, wherein one capturing unit each is configured to capture a detection surface allocated to it.

7. Apparatus according to claim 1, wherein the apparatus is configured to illuminate a surface point of the at least partially reflective surface of an object to be measured at a first point in time with a first illumination pattern so as to acquire the first reflection pattern; and to illuminate the surface point with a second illumination pattern at a second point in time different from the first point in time so as to acquire the second reflection pattern.

8. Apparatus according to claim 7, wherein the illumination device is configured to emit the first illumination pattern and the second illumination pattern along directions that are parallel and arranged offset to each other along a relative movement direction between the illumination device and the detection surface assembly on the one hand and the at least partially reflective surface on the other hand.

9. Apparatus according to claim 8, wherein a lateral offset of the two directions leads to a different path length starting from the illumination device, via the at least partially reflective surface, to the detection surface assembly, and wherein the first reflection pattern and the second reflection pattern are generated with a local difference at the detection surface assembly;
wherein the apparatus is configured to evaluate the local distance.

10. Apparatus according to claim 1, wherein the apparatus comprises a first detection surface arranged in a first distance to a surface point of the at least partially reflective surface of an object to be measure, or a second detection surface arranged in a second distances to the surface point, so that, after the reflection at the at least partially reflective surface, the illumination pattern generates the first reflection pattern upon impinging on the first detection surface and generates the second reflection pattern upon subsequently impinging on the second detection surface.

11. Apparatus according to claim 1, configured such that the first reflection pattern and the second reflection pattern are generated on a mutual detection surface of the detection surface assembly.

12. Apparatus according to claim 11, configured to generate the first reflection pattern and the second reflection pattern on a mutual main side of the mutual detection surface; and wherein the capturing unit is configured to capture the first reflection pattern and the second reflection pattern from the mutual main side.

13. Apparatus according to claim 1, configured such that the first reflection pattern is generated at a first detection surface of the detection surface assembly and the second reflection pattern is generated at a second detection surface of the detection surface assembly, wherein the first detection surface and the second detection surface are arranged offset in parallel to a relative movement direction between the illumination device and the detection surface assembly on the one hand and the at least partially reflective surface on the other hand;
wherein a first distance between the first detection surface and a first illumination source for emitting a first illumination pattern for acquiring the first reflection pattern in parallel to the relative movement direction differs from a second distance between the second detection surface and a second illumination source for emitting a second illumination pattern for acquiring the second reflection pattern in parallel to the relative movement direction.

14. Apparatus according to claim 13, wherein the first illumination source and the second illumination source are configured to emit the first illumination pattern (16₁) and the second illumination pattern along directions that are parallel to each other; and
wherein a main side of the second detection surface the reflection pattern is received from faces away from a main side of the first detection surface the first reflection pattern is received from.

15. Apparatus according to claim 1, wherein the illumination pattern comprises a multitude of points arranged along a line.

16. Apparatus according of claim 1, wherein the illumination pattern comprises a line pattern, wherein an intensity progression of the line pattern is a variable along a progression of the line.

17. Apparatus according to claim 16 wherein the intensity progression varies according to a sinusoidal function.

18. Apparatus according to claim 1, configured to simultaneously generate the first reflection pattern and the second reflection pattern at the detection surface assembly, wherein, at a point in time, the first reflection pattern is acquireed by reflection in a first surface area of the at least partially reflective surface and the second reflection pattern is acquireed by reflection in a second surface area of at least the partially reflective surface which is disjointed to the first surface area.

19. Apparatus according to claim 18, wherein the illumination device comprises a first illumination source so as to emit a first illumination pattern for acquiring the first reflection pattern; and comprises a second illumination source so as to emit a second illumination pattern for acquiring the second reflection pattern; wherein the first illumination pattern and the second illumination pattern differ from one another by an intensity distribution within the illumination pattern.

20. Apparatus according to claim 18, wherein the illumination device comprises a beam-splitting element configured to generate a first illumination signal and a second illumination signal from the output signal of a illumination source.

21. Apparatus according to claim 1, wherein the first illumination pattern differs from a second illumination pattern in a wavelength, wherein the wavelength of the first illumination pattern is selected such that a body comprising the at least partially reflective surface is mostly transparent for the same, and wherein the wavelength of the second illumination pattern is selected such that the body comprising the at least partially reflective surface is mostly non-transparent for the same.

22. Apparatus according to claim 21, wherein the capturing unit comprises a first camera adapted to the wavelength of the first illumination pattern; and a second camera adapted to the wavelength of the second illumination pattern.

23. Apparatus according to claim 1, configured to generate the first reflection pattern during a first time interval and the second reflection pattern during a second time interval at the detection surface assembly, wherein the first time interval and the second time interval are temporally disjointed.

24. Apparatus according to claim 23, wherein the apparatus is configured to illuminate a surface point of the at least partially reflective surface of an object to be measured at a first point in time with a first illumination pattern so as to acquire the first reflection pattern; and to illuminate the surface point with a second illumination pattern at a second point in time different from the first point in time so as to acquire the second reflection pattern; wherein the first reflection pattern is acquireed using a first relative position between a first illumination source for generating the first reflection pattern on the one hand and the detection surface assembly on the other hand, and wherein the second reflection pattern is acquire using a second relative position between a second illumination source for generating the second reflection pattern on the one hand and the detection surface assembly on the other hand.

25. Apparatus according to claim 1, further comprising an evaluation device configured to evaluate the at least partially reflective surface by means of correlation of the first reflection pattern and the second reflection pattern for a mutual point of the at least partially reflective surface.

26. Apparatus according to claim 1, wherein the illumination device is configured to emit an illumination pattern toward an object comprising a partially reflective surface and the at least partially reflective surface spaced apart through an at least partially transparent body;
wherein, the second reflection pattern is generated by means of a partial reflection of the illumination pattern at the partially reflective surface, and the first reflection pattern is generated by means of an at least partial reflection of a remaining portion of the illumination pattern at the at least partially reflective surface;
wherein an evaluation device is configured to inspect a surface quality of the partially reflective surface and the reflective surface by comparing the captured first reflection pattern to a first reference pattern, and by comparing the captured second reflection pattern to a second reference pattern.

27. Apparatus according to claim 1, further comprising an evaluation device configured to evaluate the first reflection pattern and the second reflection pattern.

28. Apparatus according to claim 27, wherein the evaluation device is configured to evaluate a local difference between the first reflection pattern and the second reflection pattern.

29. Apparatus according to claim 27, wherein the evaluation device is configured to evaluate the first reflection pattern and the second reflection pattern with respect to a positon in the detection surface assembly, a brightness, and/or a deformation.

30. Apparatus according to claim 1, further comprising a positioning unit configured to perform a relative movement between the illumination device and the detection surface assembly on the one hand and the at least partially reflective surface on the other hand.

31. Apparatus according to claim 30, wherein the relative movement comprises a translational movement and/or a rotational movement.

32. Apparatus according to claim 30, comprising an evaluation device configured to repeatedly acquire images from the capturing unit while the relative movement is performed, and to evaluate positions of the first reflection pattern and/or the second reflection pattern in the images.

33. Apparatus according to claim 32, wherein the evaluation device is configured to link a first image with the first reflection pattern and a second image of the second reflection pattern, wherein the first image and the second image are recorded in case of a reflection at a matching location.

34. Apparatus according to claim 1, comprising:
a first measurement assembly comprising a first detection surface; a first illumination source configured to emit a first illumination pattern toward the at least partially reflective surface so as to project, by reflection via the at least partially reflective surface, the first reflection pattern onto the first detection surface;
a second measurement assembly comprising a second detection surface; a second illumination source configured to emit a second illumination pattern toward the at least partially reflective surface so as to project, by reflection via the at least partially reflective surface, the second reflection pattern onto the first detection surface;
wherein the apparatus is configured to move the at least partially reflective surface by the relative movement from the first measurement assembly to the second measurement assembly.

35. Apparatus according to claim 1, configured to measure a lens body comprising the at least partially reflective surface.

36. Apparatus according to claim 1, wherein the illumination device comprises at least one laser projector for emitting a structured intensity distribution in the form of a laser fan beam.

37. Apparatus according to claim 1, wherein the capturing unit is configured to capture a detection surface of the detection surface assembly from a side that is arranged opposite to a side from which the second reflection pattern is reflected to the detection surface.

38. Apparatus according to claim 1, wherein the capturing unit comprises a light section camera for the position determination of the reflection pattern.

39. Apparatus according to claim 1, wherein a detection surface of the detection surface assembly is optically coupled to the capturing unit by means of a fiber optics taper.

40. Apparatus according to claim 1, wherein a detection surface of the detection surface assembly comprises a TFT panel.

41. Apparatus according to claim 1, wherein the illumination device is configured to emit the illumination pattern using a first wavelength range; wherein the detection surface assembly is configured to transpose the first wavelength range into a second wavelength range so that the first reflection pattern and/or the second reflection pattern may be captured in the second wavelength range by the capturing unit.

42. Apparatus according to claim 1, wherein the illumination device is configured to, when projecting the illumination pattern onto the detection surface assembly, consider a variable distance between the illumination device and the at least partially reflective surface and to focus onto the detection surface.

43. Apparatus according to claim 1, wherein the detection surface assembly is an active surface of an image sensor, and wherein there is no imaging optics arranged between the at least partially reflective surface and the image sensor.

44. Measurement system with at least one apparatus for capturing at least partially reflective surfaces according to claim 1, configured to measure a measurement object with a surface to be captured.

45. Method for capturing at least partially reflective surfaces, comprising;
arranging a detection surface assembly;
emitting an illumination pattern toward the at least partially reflective surface so as to project, by reflection via the at least partially reflective surface, a first reflection pattern and a second reflection pattern onto the detection surface assembly; and
capturing the first reflection pattern and the second reflection pattern from the detection surface assembly.
